(19) United States
(12) Patent Application Publication
(10) Pub. No.: US 2017/0343308 A1
(43) Pub. Date: Nov. 30, 2017

(54) CLEANING SYSTEM AND METHOD

(71) Applicant: NLB Corp., Wixom, MI (US)

(72) Inventors: Donald Anthony Wojciechowski, III, Redford, MI (US); Matthew O. Herhold, Fenton, MI (US)

(21) Appl. No.: 15/162,869

(22) Filed: May 24, 2016

(51) Int. Cl. F28G 3/16; F28D 7/16; B08B 3/02; B08B 9/023; F28G 15/02; F28G 15/00

(52) U.S. Cl. CPC F28G 3/166; F28G 15/02; F28G 15/003; B08B 3/024; B08B 9/023; F28D 7/16

(57) ABSTRACT

A cleaning system according to an exemplary aspect of the present disclosure includes, among other things, a spray cleaning head configured to expel a flow of fluid. The spray cleaning head is moveable along a cleaning path. The system further includes a control unit configured to control movement of the spray cleaning head along the cleaning path automatically. A method is also disclosed.

### BACKGROUND

This disclosure relates to cleaning systems for heat exchangers, such as tube bundles, and in particular relates an improved system and method for using the same.

Tube bundle heat exchangers are known and are used to transfer heat between a first fluid, which passes over the tube bundle, and a second fluid carried through the tube bundle. During operation, the exterior of the tube bundle may accumulate deposits from elements within the first fluid. Such deposits may inhibit heat transfer. From time to time, the tube bundles are cleaned to remove the deposits and restore efficient heat transfer.

One technique for cleaning the exterior of the tube bundles involves operation of system including a spray nozzle that is positioned by way of a crane. Known systems include a control panel hard-wired or hydraulically connected to the cleaning system. A user is required to manually position the crane during the entirety of the cleaning process using the control panel. Further, a separate control panel is used to rotate the tube bundles, to expose various surfaces of the tube bundles to the cleaning fluid. The user must devote substantial attention to the relative positions of the tube bundles and spray nozzle throughout the entirety of the cleaning process.

### SUMMARY

A cleaning system according to an exemplary aspect of the present disclosure includes, among other things, a spray cleaning head configured to expel a flow of fluid. The spray cleaning head is moveable along a cleaning path. The system further includes a control unit configured to control movement of the spray cleaning head along the cleaning path automatically. A method is also disclosed.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The drawings can be briefly described as follows:

FIG. 1 illustrates an example system according to this disclosure.

FIG. 2 is a perspective view of the spray cleaning head of FIG. 1.

FIG. 3 is another perspective view of the spray cleaning head of FIG. 1.

FIG. 4 is a side view of the system of FIG. 1, and illustrates the detail of the crane.

FIG. 5 is a side-perspective view of the system of FIG. 1, and also illustrates the detail of the crane.

FIG. 6 is a perspective view of a tube bundle supported on rollers.

FIG. 7 is a perspective view of the system of FIG. 1 in use.

FIG. 8 illustrates a user using a wireless, hand-held control unit to operate the system of FIG. 1.

FIG. 9 schematically illustrates an example cleaning path.

FIG. 10 is a flow chart representative of an example method of this disclosure.

### DETAILED DESCRIPTION

This disclosure relates to an exterior heat exchanger cleaning system and method for using the same. Such systems are sometimes known as “shell side” cleaning systems. Example heat exchangers include tube bundles, however this disclosure is not limited to tube bundle heat exchangers.

In the disclosed system, a user can position a spray cleaning head relative to a heat exchanger using a wireless, hand-held control unit. The wireless control unit can also activate rollers configured to rotate the heat exchanger being cleaned. In one example method, at least a portion of the cleaning process can be automated. Automating a portion of the cleaning process allows the user to turn attention to other tasks.

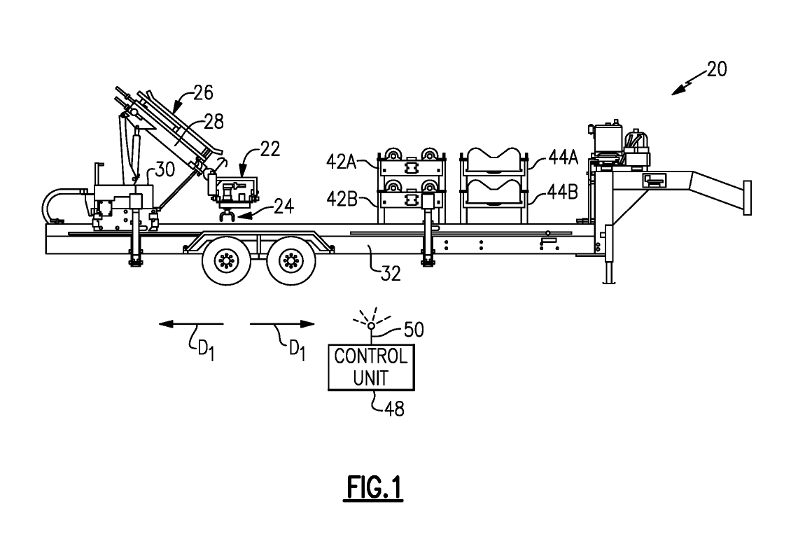

FIG. 1 illustrates an example cleaning system 20 according to this disclosure. In this example, the system 20 is an exterior heat exchanger cleaning system. Again, the system 20 is configured to clean tube bundle heat exchangers, but this disclosure is not limited to a particular heat exchanger type.

The system 20 generally includes a spray cleaning head 22 including a spray nozzle 24. The spray cleaning head 22 is mounted to a support, which in this example is a crane 26. The crane 26 is moveable to position the spray cleaning head 22. In one example, the crane 26 is a hydraulic crane.

The crane 26 includes an arm 28 which is mounted to a crane support 30. The crane support 30 is, in turn, mounted to a stationary support 32, which in this example is a truck bed. The crane support 30 is configured to travel in side-to-side directions D₁, D₂ along a track mounted to the stationary support 32, for example. The side-to-side directions D₁, D₂ run parallel to the length of the stationary support 32.

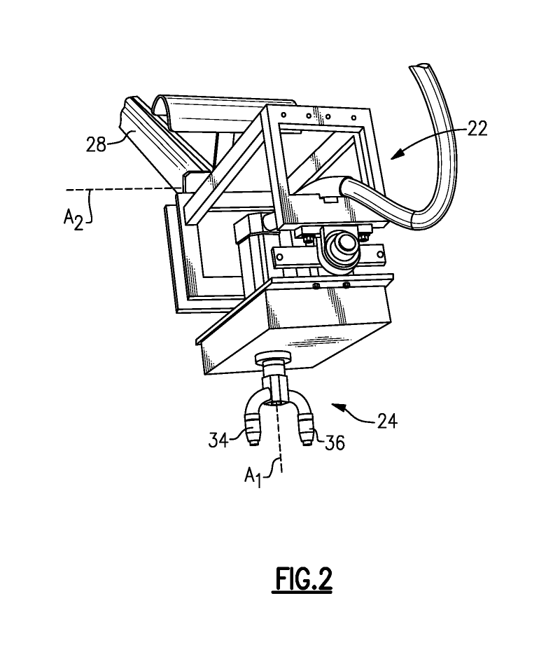

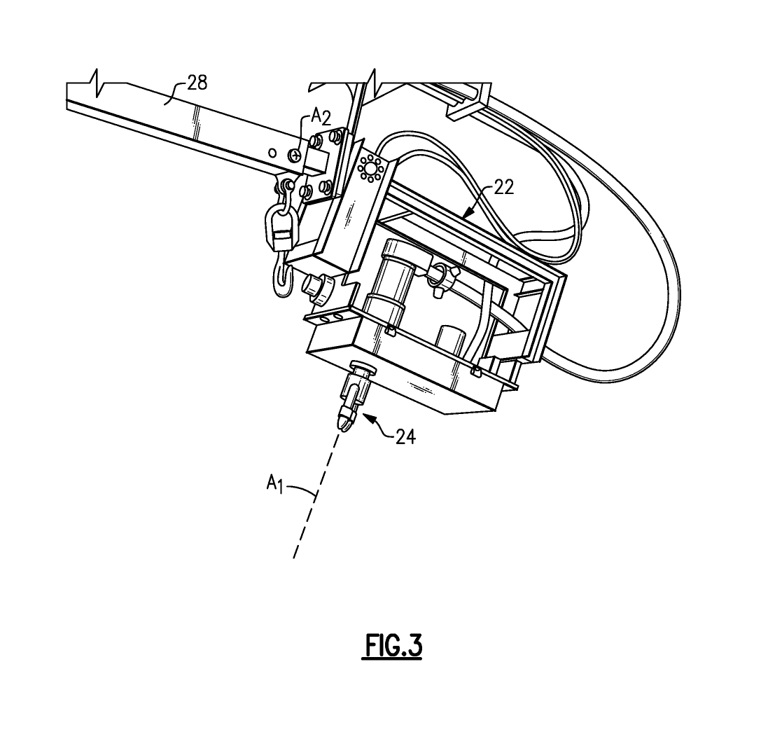

With reference to FIGS. 2-3, the spray nozzle 24 includes first and second nozzles 34, 36, configured to rotate about a first axis A₁ as relatively high pressure fluid, such as water, is expelled from the first and second nozzles 34, 36. This disclosure is not limited to use with water, and other fluids come within the scope of this disclosure. Further, while the spray nozzle 24 is shown with two nozzles, other types of spray nozzles, such as single or multiple spray nozzles, come within the scope of this disclosure. Additionally, the spray cleaning head 22 is rotatably adjustable about a second axis A₂ relative to the arm 28. Rotation about the axis A₂ positions the spray cleaning head 22 in a position that is beneficial for cleaning.

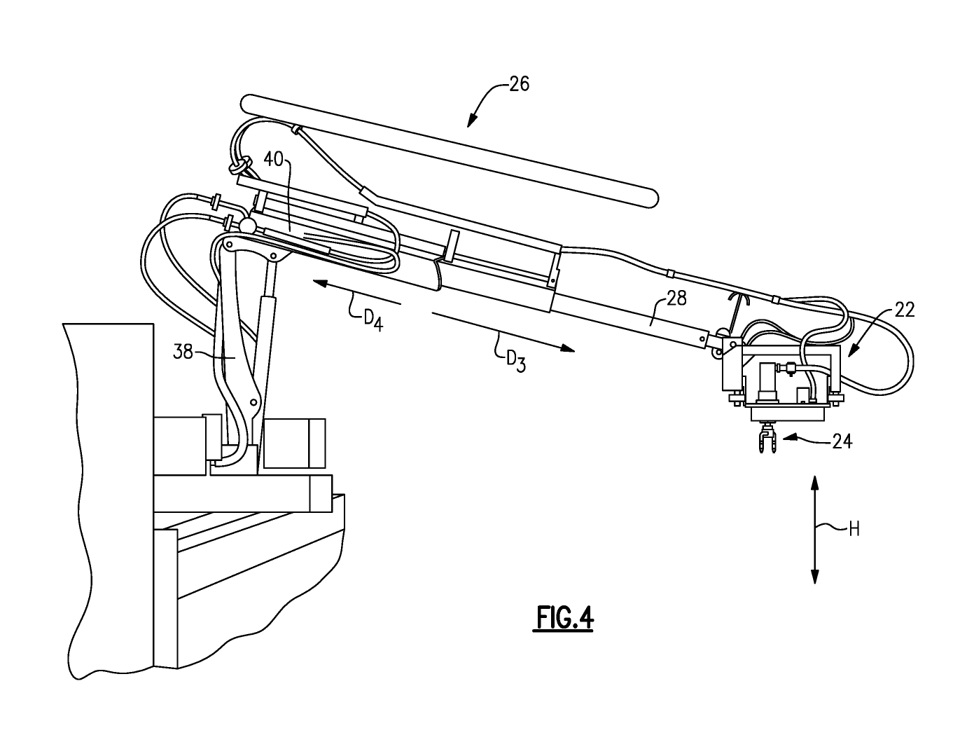

FIG. 4 illustrates the manner in which the arm 28 is configured to move in forward and rearward directions D₃, D₄ relative to the remainder of the crane 26. In this example, the directions D₃, D₄ run substantially perpendicular to directions D₁, D₂. The crane 26 includes a vertical support 38 and a horizontal support 40, each of which are configured to move to position the arm 28. The horizontal support 40 is moveable relative to the vertical support 38. The horizontal and vertical supports 38, 40 are moveable to adjust the height H of the spray cleaning head 24. The arm 28 is further moveable relative to the horizontal support 40 in the forward and rearward directions D₃, D₄. In this example, the arm 28 telescopes relative to the horizontal support 40.

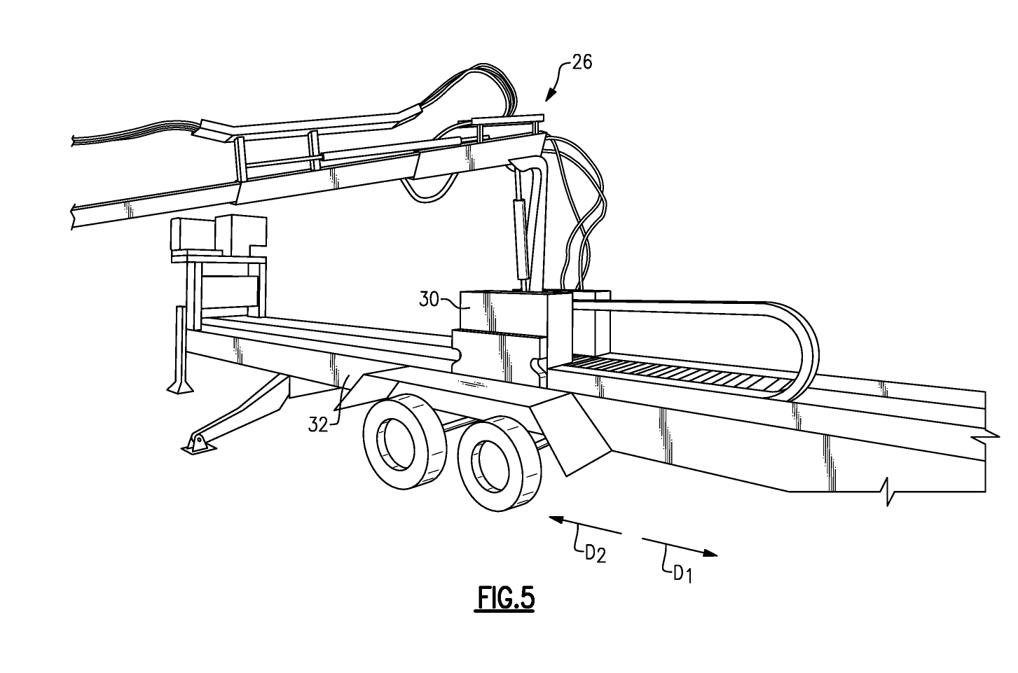

In one example, the arm 28 is moveable up to about 16.5 feet (about 5 m) away from the horizontal support 40. With reference to FIG. 5, the crane support 30 is moveable relative to the stationary support 32 in the side-to-side directions D₁, D₂ up to about 25 feet (about 7.6 m). The ranges of motion of the arm 28 and the crane support 30 correspond to an expected heat exchanger size.

With reference to FIG. 1, the system 20 includes a plurality of active rollers 42A, 42B and a plurality of passive rollers 44A, 44B. The active rollers 42A, 42B are stacked on top of one another for transport. Likewise, the passive rollers 44A, 44B are also stacked on top of one another for transport. The rollers 42A, 42B, 44A, 44B may be removed from the stationary support 32 by way of the lift.

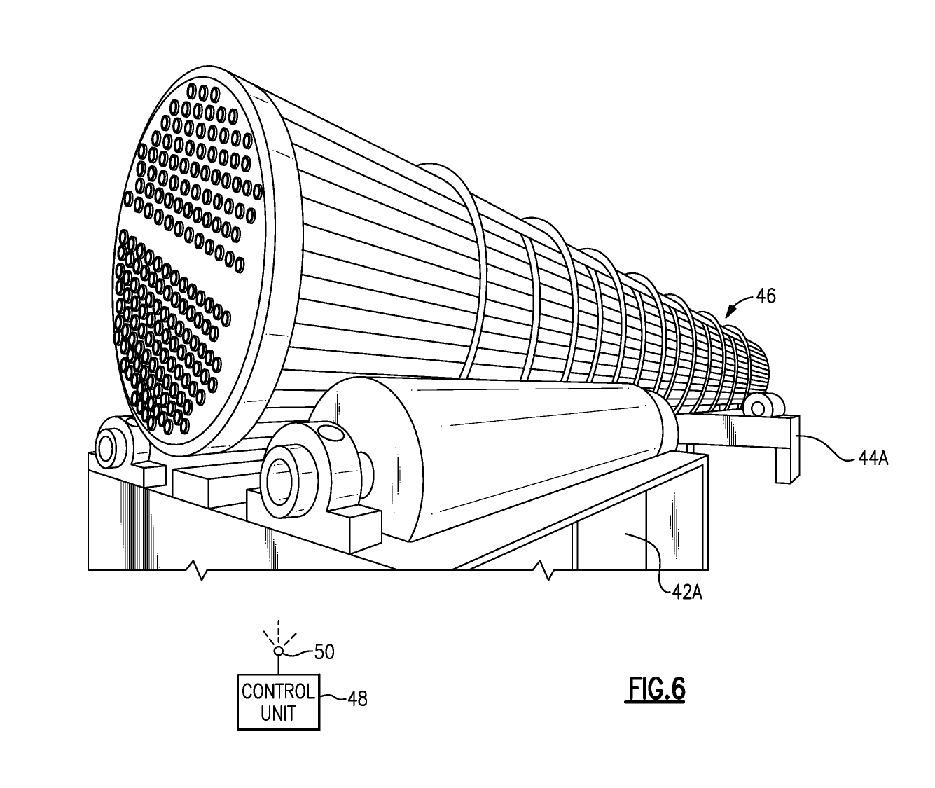

One pair of active and passive rollers (e.g., 42A and 44A) may be used to support a tube bundle, as illustrated in FIG. 6. In FIG. 6, active rollers 42A support the tube bundle 46 at one end and passive rollers 44A support the tube bundle from the other end. The active rollers 42A, upon activation, are configured to rotate and cause the tube bundle 46 to rotate, exposing additional surfaces of the tube bundle 46 to the spray cleaning head 22.

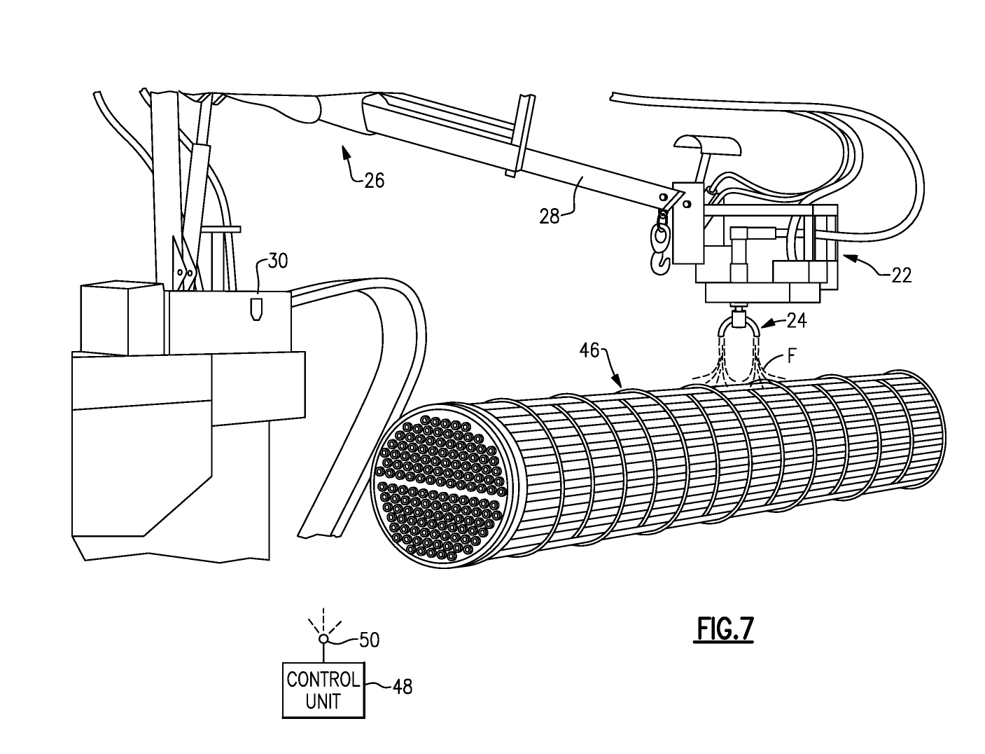

FIG. 7 illustrates the tube bundle 46 being sprayed by a fluid F expelled from the spray nozzle 24. The fluid F cleans deposits that have accumulated on the exterior surfaces of the tube bundle 46.

With reference to FIG. 1, the system 20 further includes a control unit 48. The control unit 48 includes electronics, software, or both, to perform the necessary control functions for operating the system 20. The control unit 48 may include multiple software controllers within a single device (i.e., within the control unit 48).

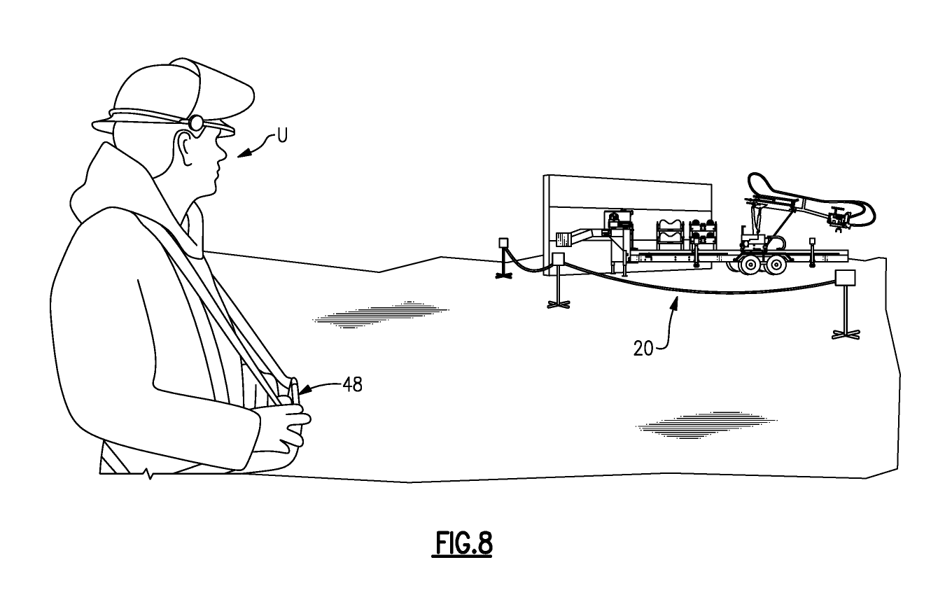

In this example, the control unit 48 is a wireless control unit including a wireless transceiver 50 configured to send and receive signals to the remainder of the system 20. Further, the control unit 48 is hand-held. Providing a hand-held, wireless control unit 48 allows the user U to operate the control unit 48 from a remote distance (see FIG. 8) relative to the remainder of the system 20. This takes the user U away from the fluid F, which increases safety.

The user U may control, among other things, the position of the spray cleaning head 22 and the rotation of the tube bundle 46 via the control unit 48. In other words, the user U can, among other things, adjust the position of the crane support 30 along the directions D₁, D₂, can adjust the position of the arm 28 along the directions D₃, D₄, and can selectively activate the active rollers 42A. As will be discussed below, the control unit 48 is also configured to control an automated cleaning operation. The control unit 48 is further configured to tilt or rotate the spray cleaning head 22 relative to the arm 28 (e.g., about axis A₂), to adjust the rotational speed of the spray nozzle 24 (e.g., about axis A₁), to adjust the height H of the spray nozzle 24 relative to the tube bundle 46, and to adjust the speed of travel along the side-to-side directions D₁-D₂.

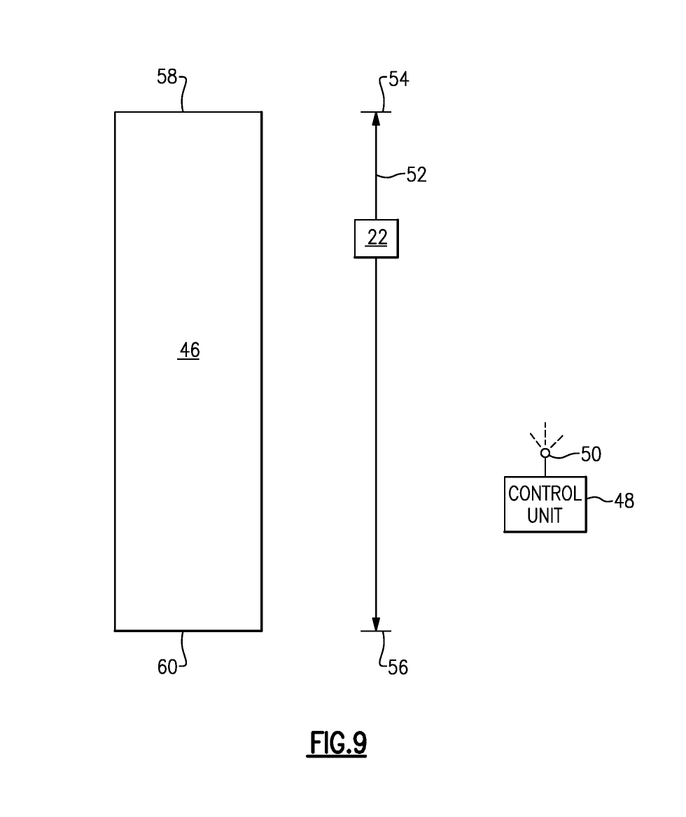

In one example automated cleaning operation, the spray cleaning head 22 is configured to automatically reciprocate back-and-forth along the length of the tube bundle 46. FIG. 9 schematically illustrates one example cleaning path 52.

In this example, the cleaning path 52 has a first end limit 54 and a second end limit 56. The first end limit 54 corresponds to a first end 58 of the tube bundle 46 and the second end limit corresponds to a second end 60 of the tube bundle 46. The end limits 54, 56 of the cleaning path 52 can be defined by the user U using the control unit 48. Alternatively, the cleaning path 52 can be pre-defined. In either case, the cleaning path 52 is selected to ensure adequate cleaning of the tube bundle 46. To this end, the spray cleaning head 22 is reciprocated, back-and-forth, in the directions D₁, D₂ to traverse the length of the tube bundle 46. The control unit 48 regulates this reciprocal movement. In one example, the reciprocal movement is automatic, which means the spray cleaning head 22 follows the cleaning path 52 completely under the direction of the control unit 48 without requiring any user input.

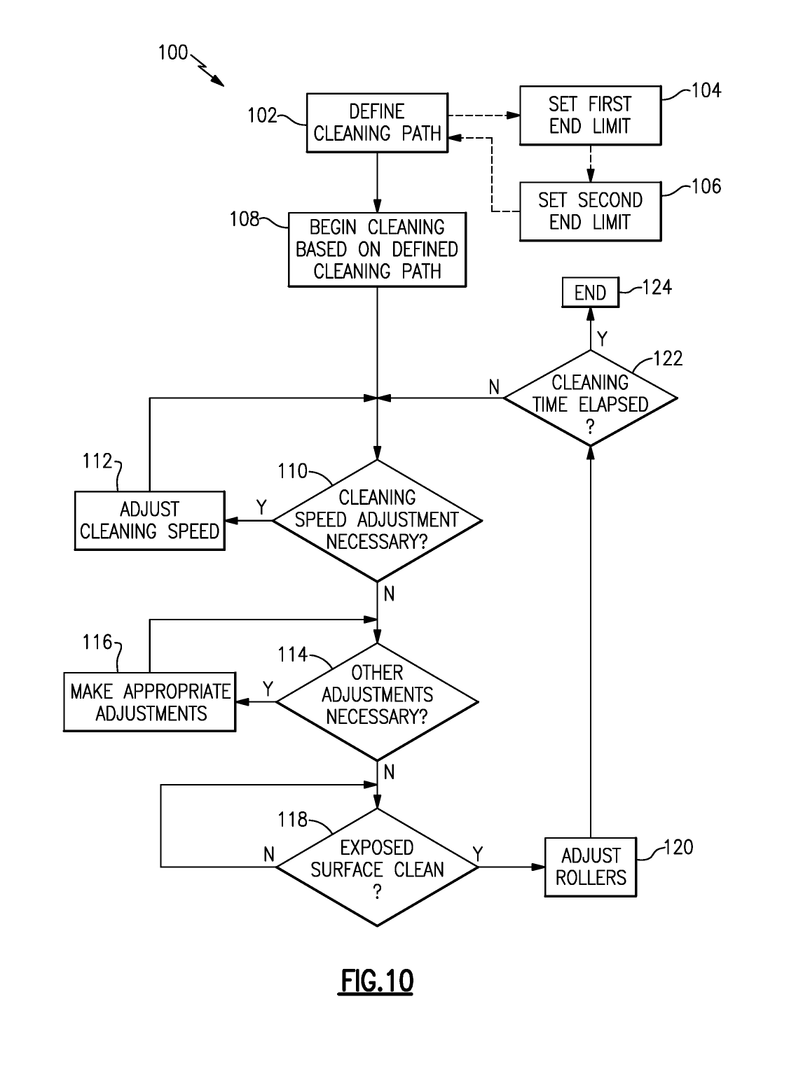

FIG. 10 illustrates one example method 100 according to this disclosure. In the method 100, the cleaning path 52 is first defined, at 102. As mentioned, the user U can define the cleaning path 52 for a particular tube bundle 46 using the control unit 48. For example, the user U can use the control unit 48 to maneuver the spray cleaning head 22 to the first end 58 of the tube bundle 46 and can then select, at 104, to set the first end limit 54. Likewise, at 106, the user U can maneuver the spray cleaning head 22 to the second end 60 of the heat exchanger and set the second end limit 56.

Once the cleaning path 52 is defined, cleaning of the tube bundle 46 begins, at 108. During cleaning, the spray cleaning head 22 moves along the cleaning path 52 in a reciprocating fashion. That is, the spray cleaning head 22 moves from the first end limit 54 to the second end limit 56, and so on. Again, the reciprocal movement of the spray cleaning head 22 along the cleaning path 52 is automatic. The user U can override or modify the movement of the spray cleaning head 22 along the spray cleaning path 52, but user U input is not required.

By automating the reciprocal movement of the spray cleaning head 22, the user U no longer needs to monitor this aspect of the operation of the system 20. Instead, the user U can focus on using the control unit 48 to adjust the position of the spray nozzles 24, the arm 28, and the rollers 44A. The user U can also attend to other tasks, such as operating an interior tube cleaner. To this end, the user U can operate the system 20 from within an interior cab of another system, such as the ATL-5000, which is an interior tube cleaning system offered by NLB Corp. Again, this increases user safety.

The spray cleaning head 22 moves along the cleaning path 52 at an adjustable speed. If the speed of the spray cleaning head 22 requires adjustment, at 110, the user U can make an appropriate adjustment, at 112. The speed may be adjustable from zero up to a predetermined threshold, which has been set to account for safety and effective cleaning. Likewise, at 114, if any number of other adjustments to the system 20 are required, the user U can make the appropriate adjustment, at 116. Example adjustments include adjustments to the angle of the spray cleaning head 22 (i.e., about axis A₂), movements of the spray cleaning head 22 in the directions D₃, D₄, movements relative to the height H of the spray cleaning head 22, and the speed of rotation of the spray nozzle 24 about the axis A₁. These adjustments can be made by the user U using a corresponding button, slider, or switch on the control unit 48.

Additionally, if the exposed surface of the tube bundle 46 is clean, at 118, the user U uses the control unit 48 to activate the rollers (e.g., 42A) to expose a surface of the tube bundle 46 that still requires cleaning, at 120. The user U does not need to access a separate, dedicated panel for the rollers, which increases efficiency.

In some examples, the spray cleaning head 22 reciprocates along the cleaning path for a predetermined amount of time. In other examples, there is no set amount of time, and the user U monitors whether the tube bundle 46 has been adequately cleaned. When there is a predetermined amount of time, however, the control unit 48 determines whether the time has lapsed, at 122, and, if so, ends the cleaning process at 124.

The disclosed system 20 is fully operable by way of a wireless control unit, which increases user safety. Further, certain aspects of the cleaning process have been automated, which frees the user to attend to other tasks. Thus, the disclosure increases safety and increases efficiency.

While in the above-discussed example, only the reciprocal movement of the spray cleaning head 22 has been automated, in other examples the position of the arm 28 may be automated throughout the cleaning cycle, the angular position of the spray cleaning head 22 relative to the arm 28 may be automated (e.g., the position of the spray cleaning head relative to angle A₂), and a rotation of the tube bundles 46 may be automated.

Further, while the above-discussed example specifically mentions a wireless control unit 48, the method 100 of this disclosure could be performed using a control unit that is capable of being hard-wired. The control unit 48 may work wirelessly and also have the option to be hard-wired in one example. This provides the control unit 48 with adaptability, such as in environments where an operator is not allowed to use wireless signals, or if the transmitter battery of the control unit 48 is no longer operable. Even when hard-wired, the wire would be sized such that the user U can stand at a safe distance during operation of the system 20.

It should be understood that terms such as side-to-side, forward, rearward, etc., are used above with reference to the normal operational attitude of the system 20. Further, these terms have been used herein for purposes of explanation, and should not be considered otherwise limiting. Terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A cleaning system, comprising:
a spray cleaning head configured to expel a flow of fluid, wherein the spray cleaning head is moveable along a cleaning path; and
a control unit configured to control movement of the spray cleaning head along the cleaning path automatically.

2. The system as recited in claim 1, wherein the cleaning path includes a first end limit corresponding to a first end of a heat exchanger, and a second end limit corresponding to a second end of the heat exchanger.

3. The system as recited in claim 2, wherein the control unit is configured to cause the spray cleaning head to move such that the spray cleaning head reciprocates between the first and second end limits along the cleaning path.

4. The system as recited in claim 3, wherein the spray cleaning head reciprocates between the first and second end limits without any user input.

5. The system as recited in claim 3, wherein a speed of the reciprocal movement of the spray cleaning head is adjustable by the control unit.

6. The system as recited in claim 1, further comprising rollers configured to support a heat exchanger, and wherein the control unit is configured to activate at least one of the rollers to adjust a position of the heat exchanger.

7. The system as recited in claim 1, wherein the control unit is wireless.

8. The system as recited in claim 7, wherein the control unit is hand-held.

9. The system as recited in claim 2, wherein the heat exchanger is a tube bundle.

10. The system as recited in claim 1, wherein the spray cleaning head is mounted to a moveable support.

11. The system as recited in claim 10, wherein the support includes a hydraulic crane.

12. The system as recited in claim 11, wherein the hydraulic crane is moveable in a side-to-side directions, and is further moveable in forward and rearward directions.

13. The system as recited in claim 12, wherein the hydraulic crane includes a crane support moveable along a track in the side-to-side directions, and further includes an arm configured to telescope relative to the remainder of the hydraulic crane in the forward and rearward directions.

14. A method, comprising:
cleaning a heat exchanger by expelling fluid from a spray cleaning head; and
moving the spray cleaning head along a cleaning path, wherein the spray cleaning head is automatically moved along the cleaning path.

15. The method as recited in claim 14, further comprising:
defining the cleaning path by setting a first end limit corresponding to a first end of the heat exchanger, and setting a second end limit corresponding to a second end of the heat exchanger.

16. The method as recited in claim 15, wherein the spray cleaning head reciprocates between the first and second end limits without requiring any user input.

17. The method as recited in claim 16, wherein a control unit is configured to control movement of the spray cleaning head.

18. The method as recited in claim 17, wherein the control unit is a wireless, hand-held control unit.

19. The method as recited in claim 18, further comprising activating a roller to adjust a position of the heat exchanger using the control unit.
